(19) United States
(12) Patent Application Publication
(10) Pub. No.: US 2006/0288958 A1
(43) Pub. Date: Dec. 28, 2006

(54) Animal harness

(75) Inventors: Brad L. Schantz, Evanston, IL (US); Donald E. Godshaw, Evanston, IL (US)

Correspondence Address: BANNER & WITCOFF, LTD., TEN SOUTH WACKER DRIVE, SUITE 3000, CHICAGO, IL, 60606, US

(73) Assignee: Travel Caddy, Inc. d/b/a Travelon, Des Plaines, IL (US)

(21) Appl. No.: 11/288,553

(22) Filed: Nov. 29, 2005

Related U.S. Application Data
(60) Provisional application No. 60/693,951, filed on Jun. 24, 2005.

(51) Int. Cl. A01K 27/00

(52) U.S. Cl. 119/792

(57) ABSTRACT

An animal harness includes a chest and girth panel with a front side, a rear-end or tail side, an abdominal or girth strap section connecting the sides to form left and right side leg openings. Lateral side straps extend from the front of the chest panel to the tail of the harness where they may be joined to together and attached to a seat belt. Adjustable buckle straps are provided to connect the top of the lateral sides of the harness to retain the harness fitted on an animal.

### CROSS-REFERENCE TO RELATED APPLICATION

This is a utility application derived from and based upon Provisional Application Ser. No. 60/693,951 filed Jun. 24, 2005 which is incorporated herewith by reference and from which priority is claimed.

### BACKGROUND OF THE INVENTION

In a principal aspect the present invention relates to an animal harness and, more particularly, to a harness that may be used for four-legged animals, particularly canine and feline animals. The harness is especially useful for vehicular travel inasmuch as it may be attached to a seat belt thereby providing a safety restraint for the animal wearing the harness.

Pets, particularly cats and dogs, often travel as a companion with their owners. During such travel the pet is often placed on a seat in a vehicle, for example the front seat on the passenger side adjacent to the driver. In the event of an accident or collision of the vehicle in which an animal is so situated, the animal is exposed to potential severe trauma. Of course, airbags may be available to reduce the impact or trauma. Nonetheless, various means for using a seat belt in order to restrain an animal have been suggested to enhance the safety of the animal. Prior art patents illustrating safety harnesses for animals include the following:

| Title | U.S. Pat. No. | Issue Date |
|---|---|---|
| VEHICULAR SAFETY RESTRAINTS | 5,794,571 | Aug. 18, 1998 |
| FOR PETS | | |
| NON-CHOKING PET RESTRAINT | 5,913,285 | Jun. 22, 1999 |
| DOG CAR RESTRAINT | 5,915,335 | Jun. 29, 1999 |
| ADJUSTABE SAFETY PET | 6,101,979 | Aug. 15, 2000 |
| HARNESS | | |

While such prior art harnesses or restraint systems may have merit, nonetheless an improved harness design which will provide enhanced protection for an animal is considered desirable. It is with this background that the present invention was conceived.

### SUMMARY OF THE INVENTION

Briefly, the present invention comprises an animal harness incorporating a multiple number of interrelated and connected component parts. The harness includes a panel which may be fitted over the chest and the girth, or abdomen, of the animal. The panel is generally symmetrical about a longitudinal axis extending from the head end toward the tail end of the panel. A left-side opening and a right-side opening on opposite sides of the longitudinal axis of the panel are provided for the front legs of the animal. The panel thus includes a front or forward end and a tail or rear end joined by first and second longitudinal sides extending between the ends. Girth section connects the opposite sides of the panel and, in combination with the chest portion of the panel, forms the openings for the right and left front legs of the animal. The harness further includes at least one connection strap for connecting the upper margins or sides of the panel to thereby provide a head opening. A reinforcing strap assembly extends longitudinally from the opening for the head or the head end of the chest panel to the tail end. The strap assembly comprises a left-hand strap and a right-hand strap located respectfully on opposite sides of the chest and girth panel extending generally parallel to the longitudinal axis between the front end and the tail end of the panel. The first and second straps are connectable at the tail end of the harness. The connected straps cooperate with a connection link or strap which, in turn, may be used to a substantially stationary position element such as a seat belt or stanchion.

In a preferred embodiment the tail ends of the left and right side straps each include a D-ring that cooperates with the single connection strap. The left and right or first and second longitudinal side straps are preferably positioned so as to extend along the lateral sides of an animal retained within the harness. Thus, in the event of a sudden stop, for example, the first and second lateral side straps will tend to cradle the animal in combination with the chest and girth panel and thereby spread the load and shock which will be imparted to the animal.

As a further preferred feature of the invention, the ends of the left and right side straps may each be folded upon themselves and retained in a retainer element so that the harness may be placed upon an animal and the side straps folded so as to not interfere with animal movement.

In a preferred embodiment, more than a single joinder strap is utilized to attach the left and right hand longitudinal sides of the chest and girth panel. The joinder straps include releasable and adjustable buckles so that the animal may be positioned within the harness in a manner where the legs will easily fit through the openings in the chest panel and the harness will be snugly fitted on the animal.

Thus, it is an object of the invention to provide an improved animal harness.

It is a further object of the invention to provide an animal harness which may be easily placed upon an animal such as a dog or cat.

Another object of the invention is to provide an animal harness having a chest panel with right-hand and left-hand lateral straps along the sides of the chest panel connectable to a restraining element such as a seat belt.

Another object of the invention is to provide an animal harness which provides for protective restraints on the lateral sides of the animal and on the forward or chest section of the animal.

A further object of the invention is to provide an animal harness which may be placed upon an animal by means of adjustable straps and buckles so that the harness may be used for animals of various sizes and shapes.

Another object of the invention is to provide an animal harness which is rugged, easy to use, inexpensive and durable.

These and other objects, advantages and features of the invention will be set forth in a detailed description which follows.

### BRIEF DESCRIPTION OF THE DRAWING

In the detailed description which follows, reference will be made to the drawing comprised of the following figures:

FIG. 1 is a front view of the animal harness of the invention positioned on a canine;

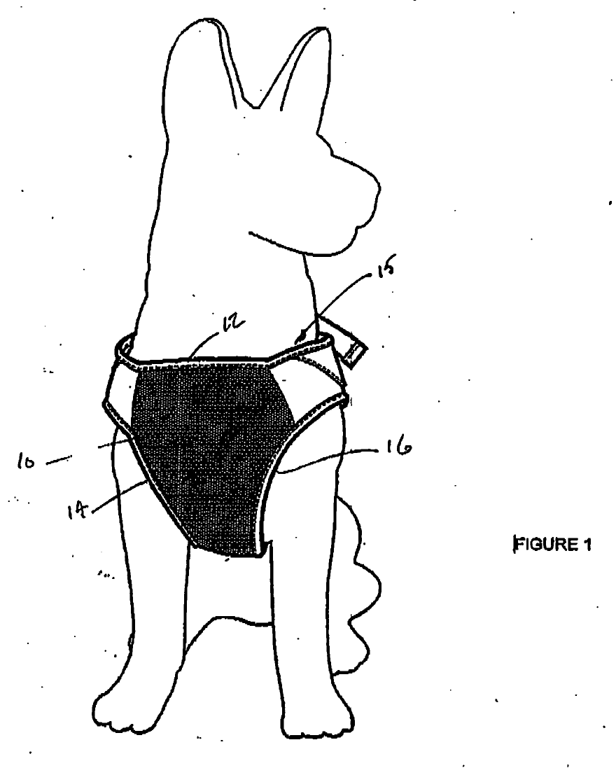

FIG. 2 is a left hand side view of the animal harness as depicted in FIG. 1;

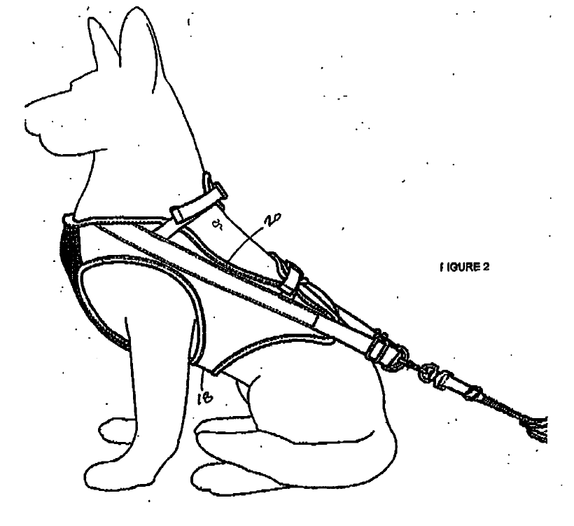

FIG. 3 is a right hand side view of the animal harness of FIG. 1;

FIG. 4 is a top view of the animal harness of FIG. 1; and

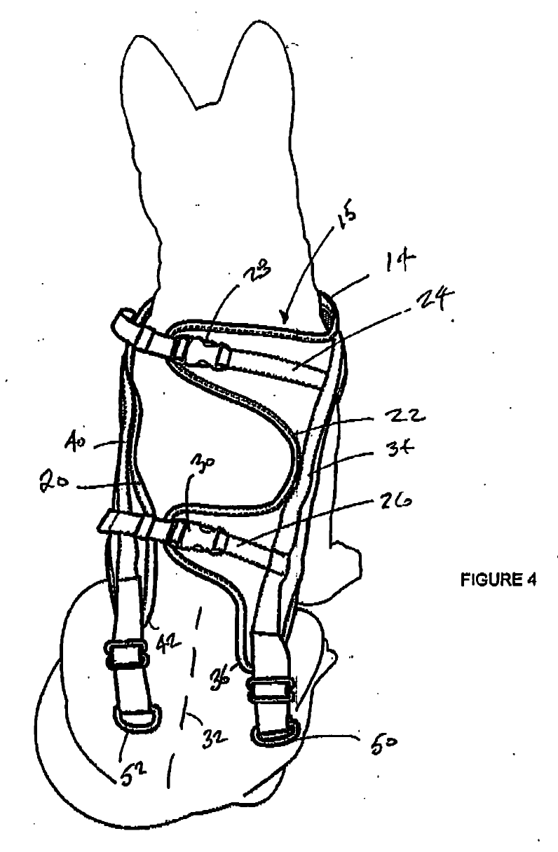

FIG. 5 is an isometric view of the animal harness of FIG. 1 on a canine positioned within a motor vehicle with the harness attached to a seat buckle.

### DESCRIPTION OF THE PREFERRED EMBODIMENT

Referring to the figures, the animal harness of the invention is particularly useful for animals such as those from the canine and feline species. However, it is not so limited and may be used with any specie of four-legged animal for protecting the animal by employing the harness in a manner which will restrain the animal and maintain the animal in a generally safe position when being transported in a vehicle, for example. That is, the animal harness of the invention can be attached to a fixed position element, such as a seat belt buckle or a stanchion, so that in the event the vehicle makes an unplanned, quick stop or other perturbation to its movement, the animal will be protected from undesirable movement and thereby, for example, prevented from being thrown into a dashboard or against a sidewall of a vehicle bed or the like. Additionally, in contrast to utilization of a neck leash, the animal harness of the invention does not expose the animal to the likelihood of a neck injury since the harness of the invention fits over and protects the full body, including the torso, of the animal.

Thus, referring to the figures, the animal harness in the form or embodiment of a dog harness, comprises a chest and girth panel 10. The chest and girth panel 10 is typically formed from a durable fabric material and may include internal or surface padding. The chest and girth panel 10 includes an upper front margin or edge 12, a right hand leg opening 14 and a left hand leg opening 16. The panel 10 extends downwardly under the chest of the animal and includes a cross member or girth panel section or strap 18 which sits against the abdomen of the animal and extends upwardly where it is connected to upper side sections 21, 23 and margins including an upper left hand margin 20 and upper right hand margin 22. First and second adjustable length connection transverse, generally parallel straps 24 and 26 include connection buckles 28 and 30, respectively, and interconnect the left and right hand margins 20, 22. An upper or forward strap 24 fits over the top of the neck of the animal. A lower or mid-body strap 26 attaches the girth or abdominal section of the panel 10. The harness includes a generally longitudinal axis 32 extending from the head to the tail and about which the harness is generally symmetrical.

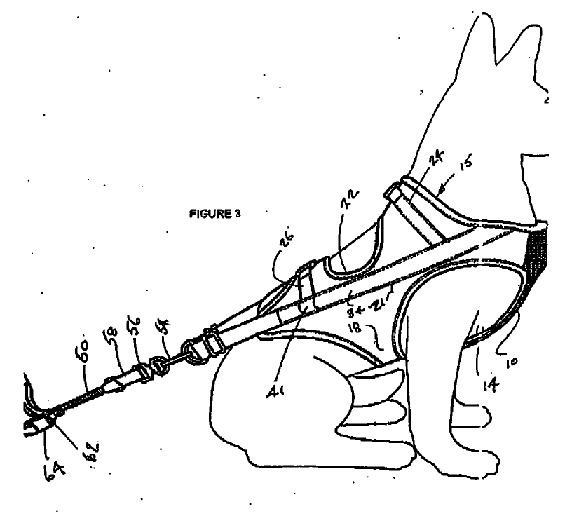

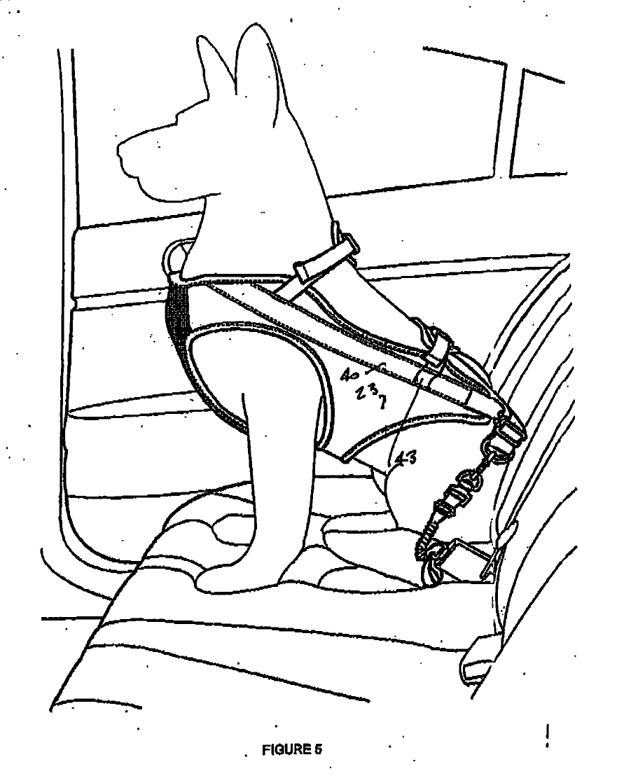

A right hand reinforcing strap 34 is stitched or attached to the right side section 21 of the panel and extends from the neck opening 14 to the tail end 36 of the harness. A left hand reinforcing strap 40 is stitched to left side section 23 and extends in similar fashion from the head or neck opening 15 to the tail end 42. The straps 34 and 40 include end D-buckles 50 and 52 which may be connected together by a carbineer 54 that, in turn, is connected to a swivel buckle 56. The swivel buckle 56 is attached to an adjustable strap 58 that attaches to an elastic or bungee cord connector 60. The bungee connector 60 attaches to a further buckle element 62 which may be latched to a seat belt buckle 64 so that the harness may be attached to a vehicle seatbelt buckle 64 as depicted, for example, in FIGS. 3 and 5.

Right side D loop or buckle 50 may be fitted through an elastic strap 41 when the ends of strap 34 are not being employed for restraint of the animal. Similarly, an elastic retainer strap 43 cooperates with the free end of strap 40 to hold buckle 52 safely.

The right side section 21 includes projective extensions 70 and 72 associated with straps 24 and 26 projecting transverse to axis 32. These extensions are padded preferably to enhance comfort and protection of the animal in the harness.

In use, the harness is first placed about the body, in particular, the front and lower torso of the animal with the chest and girth panel 10 being placed against the chest and abdomen of the animal and the straps 24 and 26 then being attached one to the other as the legs of the animal are placed through the leg openings 12 and 14. The lateral or side straps 34 and 40 may then be attached to a seatbelt buckle as, for example, depicted in FIG. 5 so that the animal may be safely retained, for example, in a car seat.

Various size versions of the harness may be utilized, depending upon the size of the animal involved. The animal may also be attached to a fixed stanchion or other connection element on the bed of a truck or other type of vehicle or in an animal cage, for example.

The harness is adjustable and in the event of a sudden stop, the optional bungee cord connection 60 will dampen sudden movement of the animal in a controlled and safe manner. Thus, if the animal is in the front seat of a motor vehicle, for example, where an air bag will provide little, if any, protection, the harness of the invention will provide significant safety advantages for the animal. In addition, the safety harness may be used in combination with a leash when the animal is being walked. For example, a leash may be attached via the carbineer 54 for movement of the dog or animal outside of a vehicle.

While there has been set forth a preferred embodiment of the invention, it is to be understood the invention is limited only by the following claims and equivalents thereof.

What is claimed is:

1. An animal harness comprising, in combination:
a girth and chest panel generally symmetrical about a longitudinal axis and including a left leg opening, a right leg opening located respectively on opposite sides of the longitudinal axis, a front end, a tail end, first and second longitudinal sides located respectively on opposite sides of the longitudinal axis;
said chest panel further including a girth strap section connecting the opposite sides of the chest panel;
a first connection strap for releasably connecting the first and second sides of the chest panel to provide a head opening;
a strap assembly mounted on the first and second sides of the chest panel extending longitudinally from the head end toward the tail end and comprising a left hand and a right hand strap connectable at the tail end; and
a connection element for releasable attachment of the strap assembly to a position restraining element.

2. The harness of claim 1 wherein the connection element is at least partially elastic.

3. The harness of claim 1 wherein the releasable attachment connection element includes a buckle member.

4. The harness of claim 1 including a releasable buckle member connecting the connection element and to the left and right longitudinal straps.

5. The harness of claim 1 including a second connection strap for connecting the first and second sides, said second connection strap positioned generally parallel to the first connection strap intermediate the first connection strap and the tail end of the chest panel.

6. The harness of claim 5 wherein the second connection strap releasably connects the first and second sides.

7. The harness of claim 1 wherein one of the first and second sides includes a chest panel extension for fitting over at least a portion of the top back side of an animal in the harness.
